(19) United States
(12) Patent Application Publication
(10) Pub. No.: US 2013/0320220 A1
(43) Pub. Date: Dec. 5, 2013

(54) Portable Radiation Detector

(71) Applicant: Michelle Donowsky, Webster, NY (US)

(72) Inventor: Michelle Donowsky, Webster, NY (US)

(21) Appl. No.: 13/488,850

(22) Filed: Jun. 5, 2012

(51) Int. Cl. G01T 1/20; B32B 3/06; G01T 1/203

(52) U.S. Cl. 250/366; 250/395; 428/99

(57) ABSTRACT

A scintillator appliance coupled to a camera aperture of a hand-held electronic device forms a radiation detector. The scintillator appliance includes a phosphor screen layer capable of producing visible light detectable by the digital camera sensor of the hand-held electronic device upon exposure to at least one type of radiation and a backer layer permitting passage of the radiation and prohibiting passage of visible light detectable by the digital camera sensor. In some embodiments, the scintillator appliance includes a filter layer between the phosphor screen layer and the backer layer. The filter layer includes at least one filter material capable of selectively filtering radiation based on at least one radiation feature. In some embodiments, the hand-held electronic device is a smartphone. An app on the smartphone preferably converts the detected visible light into a radiation dosage.

### BACKGROUND OF THE INVENTION

1. Field of the Invention

The invention pertains to the field of radiation detectors. More particularly, the invention pertains to a portable radiation detector.

2. Description of Related Art

Scintillation-based radiation detectors are commonly used to detect and quantify ionizing radiation. Scintillation-based detectors have been employed since the early 1900s (see, for example, U.S. Pat. No. 865,367, entitled “Fluorescent Electric Lamp” and issued to Edison on Sep. 10, 1907), when calcium tungstate-created light was used in combination with an x-ray tube. As evidenced by the fact that Edison's assistant, Clarence Dally, died from the exposure to x-rays, ionizing radiation presents a hazard to human health and safety and is considered a human carcinogen in the United States and elsewhere.

Ionizing radiation is difficult to detect without specialized equipment. Furthermore, its effects can be latent, sometimes taking decades to demonstrate a health effect. Since one cannot typically feel, hear, smell, or taste ionizing radiation, a method of converting radiation into quantifiable terms that are understood and accessible to the general public is needed. There are several ways ionizing radiation detection is conventionally done. Conventional instruments include scintillator probes, Geiger-Mueller probes, ion chambers, film badges, and thermal luminescent dosimeters (TLDs).

Although such devices have achieved considerable popularity and commercial success, there is a continuing need for improvement. Typically these conventional devices 1) are complicated, requiring specialized instruction for use, including reading dials and scales, requiring some scientific instrument background by the user, 2) are unavailable to the general public, being typically utilized and sold to industries such as nuclear power plants and hospitals, 3) require maintenance such as specialized batteries and gasses to be maintained, 4) contain hazardous materials themselves, such as pressurized gasses that are not easily transported, 5) are heavy, weighing as much as 1-5 pounds, 6) are large, requiring a hand to carry and not often available as a pocket sized device, 7) often do not give prompt information and require processing (especially film badges and TLDs), as long as three months, hence there is no credible warning to the wearer of the current presence of radiation, and 8) have been employed primarily for radiation medical imaging and not for general quantification of radiation or “detection” (especially scintillation screens).

For example, a conventional method for radon detection uses radon track film. The decay of radon generates alpha particles, which create tracks in the film. When the exposed detectors are returned to the laboratory, the films are processed and etched where radon decay products have interacted with the film. The tracks are then counted in an image scanner. Based on this value, as well as background and calibration factors, an exposure is calculated. This method takes valuable time and processing chemicals that are wasteful, and it can take days or weeks to get a result back to a customer.

Radiation accidents that expose the public to radiation levels of significant scale have occurred without warning and often at times when infrastructure is also compromised by natural disaster. In such events, it is difficult for the general public to acquire the specialized skills and equipment to measure ionizing radiation in the interest of personal, family, product, or business protection. Furthermore, such devices in common use, like TLDs and film badges, must be distributed and later collected for processing. This requires a significant lag time to determine radiation risk and further time and efforts to correlate such data to an area radiation dose/risk map.

Some have tried to bridge this gap by creating electronic devices that “attach” to smartphones, but essentially these are complicated, expensive individual electronic devices that merely tether to and report out to the smartphone interface.

Another example, is the emergence of a smartphone application (“app”) that measures the dark current of a smartphone camera. The WikiSensor dosimeter (WikiSensor, Paris, France) is a smartphone app that essentially only allows the user to merely measure the dark current of a phone camera created by ionizing radiation. The problem with such an arrangement is that there is poor efficiency with dark current in incoming ionizing radiation. Ionizing radiation, including x-ray radiation and gamma radiation, can easily pass through such a detector without imparting much dark current to the camera detector.

A new android-type smartphone model from Sharp Corporation (Osaka, Japan), the pantone 5 107SH, includes a dedicated built-in radiation detector. By holding down a button, the user can measure gamma ray radiation in the vicinity of the smartphone.

U.S. Pat. No. 6,346,707, entitled “Electronic Imaging System for Autoradiography” and issued to Vizard et al. on Feb. 12, 2002, discloses an imaging assembly including a prompt phosphor layer for converting an ionizing radiation image into a light image and a transparent layer supporting the phosphor layer. The light image is transmitted through the transparent layer. An electronic camera converts the light image into an electronic image. A light image transmission system between the imaging assembly and the electronic camera transmits the light image to the electronic camera.

U.S. Pat. No. 7,391,028, entitled “Apparatus and Method for Detection of

Radiation” and issued to Rubenstein on Jun. 24, 2008, discloses using digital images or the charge from pixels in light-sensitive semiconductor-based imagers to detect gamma rays and energetic particles emitted by radioactive materials. Pixel-scale artifacts introduced into digital images and video images by high energy gamma rays are identified. Statistical tests and other comparisons on the artifacts in the images or pixels are used to prevent false-positive detection of gamma rays. The sensitivity of the system allows detection of radiological material at distances in excess of 50 meters. Advanced processing techniques allow for gradient searches to determine the source's location and to identify the specific isotope. Non-radioactive objects are separated from radioactive objects.

The above-mentioned references are hereby incorporated by reference herein.

### SUMMARY OF THE INVENTION

A scintillator appliance coupled to a camera aperture of a hand-held electronic device forms a radiation detector. The scintillator appliance includes a phosphor screen layer capable of producing visible light easily detectable by the digital camera sensor of the hand-held electronic device upon exposure to at least one type of radiation and a backer layer permitting passage of the radiation and prohibiting passage of visible light detectable by the digital camera sensor. In some embodiments, the scintillator appliance includes a filter layer between the phosphor screen layer and the backer layer. The filter layer includes at least one filter material capable of selectively filtering radiation based on at least one radiation feature. In some embodiments, the hand-held electronic device is a smartphone. An app on the smartphone preferably converts the detected light into a radiation dosage.

In some embodiments, an appliance converts forms of ionizing radiation into visible light that is easily detectable by an electronic device. In some embodiments, the device is a smartphone with a digital camera. The appliance preferably includes an exterior housing with an attachment mechanism to couple the appliance to the electronic device. The housing may be made of any of a variety of synthetic or metal materials, including, but not limited to, aluminum or plastic. The housing is arranged in a manner to affix the appliance to the camera.

A number of different attachment mechanisms may be used within the spirit of the present invention, including, but not limited to, an elastic band such that the device may be worn as a bracelet, suction cups, a magnetic medium, an elastic press fitting, a threaded fitting, a rotatable disk-type device that accommodates different radiation screens and filters, a specialized adjustable clamp that accommodates a wide variety of cameras and aperture shapes, and an adhesive, including, but not limited to, a peel and stick adhesive.

### BRIEF DESCRIPTION OF THE DRAWINGS

FIG. 1 shows an x-ray radiation/gamma radiation detector in an embodiment of the present invention.

FIG. 2 shows an alpha radiation/radon detector in an embodiment of the present invention.

FIG. 3 shows an enhanced x-ray radiation/gamma radiation/high energy beta radiation detector in an embodiment of the present invention.

FIG. 4 shows an enhanced x-ray radiation/gamma radiation/high energy beta radiation detector in another embodiment of the present invention.

FIG. 5 shows an enhanced neutron-sensitive detector in an embodiment of the present invention.

FIG. 6 shows a remote scintillator appliance in an embodiment of the present invention.

### DETAILED DESCRIPTION OF THE INVENTION

A prompt-emitting phosphor screen or scintillator appliance, sensitive to x-rays and other forms of ionizing radiation, is coupled, such as by an adhesive, a lens cover, or a flexible band, to the camera aperture of a device. The phosphor appliance is preferably re-useable, small, portable, and does not require permanent alteration of the electronic device. The electronic device is preferably hand-held. In some embodiments, the device is a cellular telephone, preferably a smartphone. In other embodiments, the electronic device is a laptop computer. In other embodiments, the electronic device is a tablet computer. The phosphor appliance preferably has the following features:

1) Passive—Requiring no power or electronics to perform its function. Requires no physical alteration to the electronic device;

2) Requiring no permanent affixing or alteration—it can be removed, restoring the electronic device to its original configuration;

3) Reuseable essentially an unlimited number of times;

4) Small and lightweight—preferably as small as a common coin permitting easy transport so that it can be applied and used at anytime;

5) Integratable into protective electronic device “skins”, sheaths, covers, or protective barriers providing a simultaneous function to an already existing appliance used on or with phones; and

6) Rapidly integratable into GPS data logging or mapping of radiation—permitting a rapid analysis of radiation dispersion across a large area such as a town, city, county, state, or country.

In some embodiments, the phosphor appliance is part of a dedicated, self-contained electronic device. In some embodiments the electronic device may be worn on the wrist similar to a wrist watch. In some embodiments, the dedicated, self contained electronic device may include other features such as an alarm or a time display.

Furthermore, in a manner similar to switching lenses on a camera for specific conditions, additional other appliances may be used that can emit light upon the digital detector for specific applications.

The specific embodiments shown in the drawings are not the only ones that may be utilized. Other arrangements of fixtures, affixing, phosphors, lenses, filters, reflectors, and light/radiation scattering agents may be utilized within the spirit of the present invention to:

1) Accommodate specific types of radiation, including, but not limited to, alpha, beta, gamma, x-ray, and neutron radiation, and specific frequencies and energies of radiation, including both ionizing and non-ionizing;

2) Increase interaction with the phosphor or camera sensor for better sensitivity;

3) Accommodate a variety of different electronic devices and their protective covers;

4) Accommodate a variety of environmental conditions that may impact usability, including, but not limited to, water permeation, heat, and cold;

5) Accommodate more than one radiation cover/sensor/filter so that a variety of different sensors and filters may be stacked, rotated, or otherwise introduced in front of the camera image sensor.

In some embodiments, a scintillation screen, a smartphone, and a smartphone app are coupled to create a low-cost radiation detector. The prompt phosphor media or screen, which may be of any composition with any variety of filter screens, emits photons promptly in the visible through infrared spectrum. The screen is affixed to cover the digital camera aperture of the smartphone or other portable electronic device. The camera collects the photons emitted from the screen, and the software app quantifies the relative signal intensity by relating it to the increased presence of radiation and radiation exposure or dose rate.

Specific ways in which this radiation detector may be used include, but are not limited to, as a digital radon detector, a radioactive contamination (e.g. “fallout”) detector, a radiation exposure rate meter, a personal dosimeter with built-in alarm for preset radiation levels, a radiation exposure count meter counting the number of times someone is exposed to repeated exams involving radiation; and an emergency or other radiation detector that correlates radiation intensity with geographic location (e.g. “photo geotagging”) so that emergency responders and associated emergency management can rapidly assess radiation intensities promptly based on geographic location.

A software application, and more specifically a smartphone app, preferably complements the appliance to provide an aesthetically pleasing and useful look to the software interface, and matches up the radiation levels to a reasonably acceptable range of accuracy. The app preferably includes a visual and audible “alert”, such as a graphical interface and audible alarm that increases and decreases in volume, frequency, or pitch with radiation intensities.

The software application analyzes and displays the results of the data capture, including, but not limited to, an interpreted meaning for non-expert users. Raw and interpreted data are preferably delivered in real time and stored as data deliverable in usable formats for researchers, government agencies, industrial users, and enthusiasts.

Data capture result displays preferably include, but are not limited to, an alphanumeric description using various commonly used units of measure, color-coded levels of danger, one or more audible signals, multidimensional colorized signal mapping, one or more histograms, and a scalable geographical magnitude relative to other geo-tagged locations (topographical map of type and magnitude).

The associated application preferably operates directly on a capture device, which may include, but is not limited to, any model of smartphone, tablet computer, laptop, or desktop computer fitted with built in or add-on camera. Alternatively, the associated application may operate on a laptop or desktop computer, where the capture data is delivered by any means for analysis and display. The associated software and hardware applications preferably include a correction algorithm to compensate for stray or dark current, ambient light, and various other variables inherent in the camera electronics and external environment.

Together these features preferably create a device with the following characteristics:

1) Easy access—Availability through the app stores already integrated into phone software systems;

2) Immediate results—Unlike film, TLD, Luxel (Luxel Corporation, Friday Harbor, Wash., USA), and storage phosphors, which require timely processing or specialized training, the smartphone/phosphor combination may provide immediate results and feedback, so that a wearer is able to take protective actions sooner. As an emergency response tool, the device may also geotag coordinates of the photo (measuring location);

3) Portable and convenient—Being located on a device carried for a multitude of other purposes, smartphone radiation detection is much more portable and accessible. In a manner similar to how phone-based photography has usurped specialized, separate camera and film photography, smartphone radiation detection may usurp other modalities of radiation detection, simply based on the incredible convenience, even if the radiation detection might happen to be not quite as accurate as for the more expensive devices;

4) No advanced training required—Like most smartphone apps, the app is preferably an intuitive interface that is simple to use, essentially using the phone interface, typically a touch screen;

5) Alarm for predetermined exposure level—When the electronic device is in video mode, the application can calculate accumulated exposure; and

6) Geotagging—A smartphone camera app is an excellent modality to incorporate a geotagging feature.

Geotagging is the process of adding geographical identification metadata to various media, such as geotagged photographs, videos, websites, SMS (Short Message Service, i.e. “text”) messages, QR (Quick Response) codes, and RSS (Really Simple Syndication) feeds, and is a form of geospatial metadata. These data usually include latitude and longitude coordinates, although they may also include altitude, bearing, distance, accuracy data, and place names. Geotagging is commonly used for photographs, giving geotagged photographs.

Geotagging provides a prompt, effective, mass-volume way of determining radiation intensities relative to geo-spatial location and may even be used to map radiation levels.

Emergency responders or the mass public following a nuclear accident or event may gather useful geographic location and simultaneous radiation intensities to determine fallout patterns, emergency egress, and access pathways.

Essentially, when ionizing radiation interacts with a digital camera, the wavelengths are invisible to the camera and there is no practical means to quantify or determine radiation levels from it. By placement of a prompt phosphor screen affixed over the aperture, either with or without filtration depending on the type of radiation to be measured, the ionizing radiation, which may include, but is not limited to, alpha particles, beta particles, neutrons, x-rays, or gamma rays, create light, which is visible to the camera sensor, which is typically a CCD (Charge-Coupled Device) or CMOS (Complementary Metal-Oxide-Semiconductor) sensor.

The total amount of light entering the camera over time while covered with the appliance correlates to the radiation intensity or rate. The amount of integrated area under this curve (incoming light over time) correlates to radiation “dose” or “rate”, i.e. the total amount of radiation that has dumped into a specific point where the detector is located at any given moment.

Software within the app preferably summarizes the incoming radiation and records or reports dose or dose rate information. There are several ways this may be done, and it may be specialized for various types of radiation, as explained below.

### Basic Radiation Detector

A basic radiation detector utilizes a prompt phosphor, such as gadolinium oxysulfide (Gd₂O₂S or GOS), commonly utilized in x-ray films, affixed in front of a smartphone aperture. The ambient light is preferably prevented from entering the aperture, so that the only visible light going to the camera is that from the phosphor screen.

As previously described, the ionizing radiation (gamma/x-ray/high energy beta) interacts with the phosphor, creating visible light easily detectable to the digital camera sensor. The app software monitors the amount of overall light being produced and correlates the intensity or light rate to a radiation intensity rate (e.g. milliroentgens per hour). The amount of intensity quantified over time may be extrapolated into an absorbed radiation (e.g. dose). A visual interface on the smartphone display may be used to demonstrate real time radiation rates and quantify (integrate) dose.

Enhanced High/Low Energy/Multiple Agent Radiation Detector with Filtration

The filters may include various densities of materials or plastics. In various embodiments, a single screen may contain a series of filters of different thicknesses or the absence of filters and different materials. The particular choice may be determined by the environment to be monitored. The use of several different thicknesses allows an estimation of the energy/wavelength of the incident radiation.

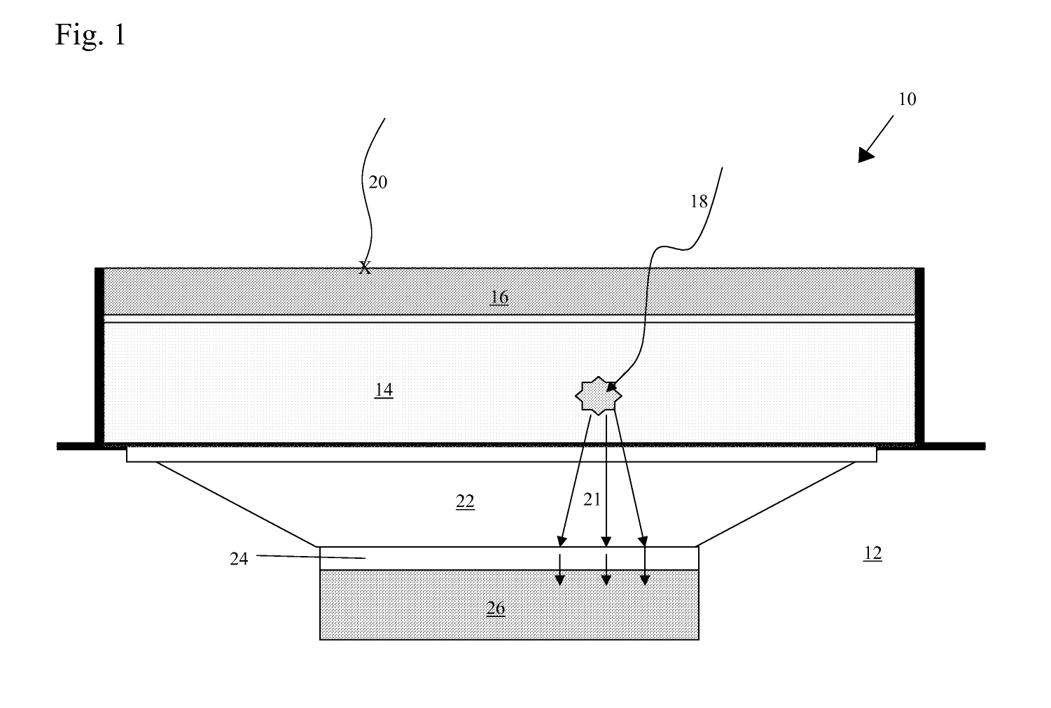

The appliance may take on a form other than those shown specifically in FIGS. 1-5. Filter materials, phosphors, and any combination thereof may be utilized to create different responses and photon outputs to the digital camera imager (CCD/CMOS) sensors. For example, a filter and phosphor array may be assembled so that a high-energy filter is coupled to a phosphor that emits blue light and a low-energy filter is coupled to a phosphor that creates green light. Since a digital camera can discern the differences in color output, the mentioned arrangement permits the discernment of the amount and presence of high-energy radiation versus low-energy radiation, which is often valuable for quantifying dose equivalency in human tissue and for determining the type of radiation, including identifying the type and source of radiation so that the user may make an informed decision about personal protection.

### X-Ray Exam “Counting” Device

In another embodiment, the software within an app tracks dose and counts pulses of radiation. In some embodiments, the device counts the number of exposures. Since ambient radiation remains relatively constant, pulses may be easily counted to determine the number of x-ray “shots” taken during an exam. Cases of overexposure to x-ray radiation in diagnostic medical tests reported in the media highlight the potential hazards of a lack of warnings to a patient or a clinician that repeat exams have taken place. Had a device been present to count the number of exposure shots taken, injury could have been prevented in most cases. An active campaign called the Image Gently™ campaign asks persons, especially parents, to simply download a paper card and document tests, especially on children, with exam type and date. The problem with this process is that it does not actively measure how many times a person was actually exposed to radiation, nor if they were repeatedly exposed due to operator or technical error.

In such an embodiment, the device may be placed on the person's body or discreetly in their pocket, outside the field of the x-ray image. The pulse of surrounding x-ray scatter increases and decreases with every shot and hence may be quantified as one exposure. If a clinician repeats an exam, or the exam requires several “views” this may be documented by the device. If the presence of the smartphone sensor is made known to the clinician, it may reduce bad practices by signaling to the clinician that they are being monitored and to be “extra careful”, hence preventing some over exposures that would otherwise go unnoticed by institution or patient.

### Screening/Scintillator Media/Materials

A variety of scintillators may be utilized in the appliance. For example, sodium iodide crystals or a plastic scintillator may be used in lieu of phosphor screens.

In a preferred embodiment, the phosphor is prompt, meaning that it can automatically create light that is visible to the camera without any further interaction or manipulation by the user. The phosphor is preferably also durable, stable, reusable, light, and small enough to be carried and applied without device modification. The phosphor is preferably also of reasonable quality and expense so that it is reliable and affordable to the average consumer (e.g., smartphone owner) and within the range of cost of common smartphone apps.

There are many different types of scintillators/phosphors that may be used in the appliance, including, but not limited to:

Organic Crystals

Organic scintillators are aromatic hydrocarbon compounds which contain benzene ring structures interlinked in various ways. Their luminescence typically decays within a few nanoseconds (ns).

Some organic scintillators are pure crystals. The most common types are anthracene (C₁₄H₁₀, decay time of about 30 ns), stilbene (C₁₄H₁₂, decay time of a few ns), and naphthalene (C₁₀H₈, decay time of a few ns). They are very durable, but their response is anisotropic, which spoils the energy resolution when the source is not collimated, and they are not easily machined, nor can they be grown in large sizes. Hence they are not very often used. Anthracene has the highest light output of all organic scintillators and is therefore conventionally chosen as a reference. The light output of other scintillators is sometimes expressed as a percent of anthracene light.

Organic Liquids

Liquid solutions may include one or more organic scintillators in an organic solvent. Typical solutes include, but are not limited to, fluors such as p-terphenyl (C₁₈H₁₄), PBD (C₂₀H₁₄N₂O; 2-[1,1′-biphenyl]-4-yl-5-phenyl-1,3,4-oxadiazole), butyl PBD (C₂₄H₂₂N₂O), PPO (C₁₅H₁₁NO; 2,5-diphenyloxazole), and wavelength shifters such as POPOP (C₂₄H₁₆N₂O₂; 1,4-bis(5-phenyloxazol-2-yl)benzene). The most widely used solvents are toluene, xylene, benzene, phenylcyclohexane, triethylbenzene, and decalin. Liquid scintillators may be loaded with other additives, such as wavelength shifters, to match the spectral sensitivity range of a camera or CCD or CMOS digital camera detector that may be enclosed within a smartphone. For many liquids, dissolved oxygen acts as a quenching agent and leads to reduced light output, hence the solution is preferably sealed in an oxygen-free, air-tight enclosure.

Plastic Scintillators

The term “plastic scintillator”, as used herein, refers to a scintillating material in which the primary fluorescent emitter, or fluor, is suspended in a solid polymer matrix base. While this combination is typically accomplished though the dissolution of the fluor prior to bulk polymerization, the fluor is sometimes associated with the polymer directly, either covalently or through coordination, as is the case with many Li-6 plastic scintillators. Polyethylene naphthalate has been found to exhibit scintillation by itself without any additives and is expected to replace existing plastic scintillators due to higher performance and lower price. The advantages of plastic scintillators include fairly high light output and a relatively quick signal, with a decay time in the range of 2-4 nanoseconds. Perhaps the biggest advantage of plastic scintillators is their ability to be shaped, such as through the use of molds, into almost any desired shape with a high degree of durability.

Bases

The most common bases are aromatic plastics, polymers with aromatic rings as pendant groups along the polymer backbone, with polyvinyltoluene (PVT) and polystyrene (PS) being the most prominent. While the base does fluoresce in the presence of ionizing radiation, its low yield and negligible transparency to its own emission make the use of fluors necessary in the construction of a practical scintillator. Aside from the aromatic plastics, the most common base is polymethylmethacrylate (PMMA), which has two advantages over many other bases: high ultraviolet and visible light transparency and higher durability with respect to brittleness. The lack of fluorescence associated with PMMA may be compensated through the addition of an aromatic co-solvent, often naphthalene. A plastic scintillator based on PMMA in this way is transparent to its own radiation, helping to ensure uniform collection of light.

Other common bases include, but are not limited to, polyvinyl xylene (PVX); polymethyl, 2,4-dimethyl, 2,4,5-trimethyl styrenes; polyvinyl diphenyl; polyvinyl naphthalene; polyvinyl tetrahydronaphthalene; and copolymers of these and other bases.

Fluors

Also known as luminophors, fluors are compounds that absorb the scintillation of the base and then emit at a larger wavelength, effectively converting the ultraviolet radiation of the base into the more easily transferred visible light. Further increasing the attenuation length may be accomplished through the addition of a second fluor, referred to as a spectrum shifter or converter, often resulting in the emission of blue or green light.

Common fluors include, but are not limited to, polyphenyl hydrocarbons; oxazole; oxadiazole aryls, especially, n-terphenyl (PPP); 2,5-diphenyloxazole (PPO); POPOP; PBD; and 2-(4′-tert-butylphenyl)-5-(4″-biphenylyl)-1,3,4-oxadiazole (B-PBD).

Inorganic Scintillators and Screen Media

Inorganic scintillators are usually crystals grown in high-temperature furnaces, for example, alkali metal halides, often with a small amount of activator impurity. The most widely used is NaI(Tl) (sodium iodide doped with thallium). Other inorganic alkali halide crystals include, but are not limited to, CsI(Tl), CsI(Na), CsI(pure), CsF, KI(Tl), LiI(Eu). Non-alkali crystals include, but are not limited to, BaF₂, CaF₂(Eu), ZnS(Ag), CaWO₄, CdWO₄, YAG(Ce) (Y₃Al₅O₁₂(Ce)), Gd₂SiO₅(Ce) (GSO), and Lu₂SiO₅(Nd) LSO, many of which are described in more detail below.

Newly-developed crystals include cerium-doped lanthanum chloride (LaCl₃(Ce)), as well as cerium-doped lanthanum bromide (LaBr₃(Ce)). Both are very hygroscopic (i.e., damaged when exposed to moisture in the air) but offer excellent light output and energy resolution (63 photons/keV gamma for LaBr₃(Ce) versus 38 photons/keV gamma for NaI(Tl)), a fast response (16 ns for LaBr₃(Ce) versus 250 ns for NaI(Tl)) with excellent linearity, and a very stable light output over a wide range of temperatures. In addition LaBr₃(Ce) offers a higher stopping power for gamma rays (density of 5.08 g/cm³ versus 3.67 g/cm³ for NaI(Tl)). LYSO (Lu_{1.8}Y_{0.2}SiO₅(Ce)) has an even higher density (7.1 g/cm³, comparable to Bi₄Ge₃O₁₂ (BGO)), is non-hygroscopic, and has a higher light output than BGO (32 photons/keV gamma), in addition to being rather fast (41 ns decay time versus 300 ns for BGO).

A disadvantage of some inorganic crystals, including NaI, is their hygroscopicity, a property which requires them to be housed in an air-tight enclosure to protect them from moisture. CsI(Tl) and BaF₂ are only slightly hygroscopic and usually do not need protection. CsF, NaI(Tl), LaCl₃(Ce), and LaBr₃(Ce) are hygroscopic, while BGO, CaF₂(Eu), LYSO, and YAG(Ce) are not.

Inorganic crystals may be cut to small sizes and arranged in an array configuration so as to provide position sensitivity. Such arrays are used in medical physics or security applications to detect x-rays or gamma rays. High atomic number, high density materials, such as LYSO or BGO, are typically preferred for these types of applications.

Scintillation in inorganic crystals is typically slower than in organic ones, ranging typically from 250 ns for NaI(Tl) to 1000 ns for CsI(Tl). Exceptions are CsF (about 5 ns) and fast BaF₂ (0.7 ns; the slow component is at 630 ns), as well as the more recently developed crystals (LaCl₃(Ce), 28 ns; LaBr₃(Ce), 16 ns; LYSO, 41 ns).

Common inorganic scintillators include, but are not limited to:

Gadolinium oxysulfide (GOS; Gd₂O₂S)—GOS is frequently used as a scintillator for x-ray imaging and emits at wavelengths between 382-622 nm, with a primary emission peak at 545 nm, a wavelength easily detected by a digital camera.

Barium fluoride (BaF₂)—BaF₂ contains a very fast and a slow component. The fast scintillation light is emitted in the UV band (220 nm) and has a 0.7 ns decay time, the smallest decay time for any known scintillator, while the slow scintillation light is emitted at longer wavelengths 310 nm.

Europium-doped calcium fluoride (CaF₂(Eu))—CaF₂(Eu) has a 940 ns decay time and is relatively low atomic number. The latter property makes it ideal for detection of low energy beta particles because of low backscattering, but not very suitable for gamma detection. Thin layers of CaF₂(Eu) have also been used with a thicker slab of NaI(Tl) to make phoswich detectors capable of discriminating between alpha, beta, and gamma particles.

Bismuth germinate (BGO)—BGO has a higher stopping power but a lower optical yield than NaI(Tl) and may be suitable for higher energy sources of radiation such as cobalt-60 where the incident gamma rays are greater than 1 MeV in energy.

Cadmium tungstate (CdWO₄)—CdWO₄ is a high-density, high-atomic number scintillator with a very long decay time (14 μs), and relatively high light output (about ⅓ of that of NaI(Tl)). CdWO₄ is routinely used for x-ray detection and may also be suitable for low activity counting of radon and associated progeny.

Thallium-doped cesium iodide (CsI(Tl))—CsI(Tl) crystals are one of the brightest scintillators. The maximum wavelength of light emission (550 nm) is rather high, however, making CsI(Tl) best coupled to red-enhanced photomultiplier tubes (PMTs) or to photo-diodes.

Sodium-doped cesium iodide (CsI(Na))—CsI(Na) crystals are less bright than CsI(Tl), but are comparable in light output to NaI(Tl). The wavelength of maximum emission is at 420 nm, well matched to the photocathode sensitivity of digital cameras. CsI(Na) is hygroscopic and needs an air-tight enclosure for protection against moisture.

Cesium iodide (CsI)—Undoped cesium iodide emits predominantly at 315 nm, is only slightly hygroscopic, and has a very short decay time (16 ns), making it suitable for fast timing applications. The light output is quite low, however, and highly sensitive to variations in temperature.

Cerium-doped lanthanum bromide (LaBr₃(Ce))—LaBr₃(Ce) is a better alternative to NaI(Tl) in that it is denser, much faster, and offers superior energy resolution due to its very high light output. Moreover, the light output is very stable and quite high over a very wide range of temperatures, making it particularly attractive for high temperature applications.

Cerium-doped lanthanum chloride LaCl₃(Ce)—LaCl₃(Ce) is very fast with a high light output. LaCl₃(Ce) is a cheaper alternative to LaBr₃(Ce) but is also quite hygroscopic.

Lead tungstate (PbWO₄)—Due to its high atomic number, PbWO₄ is suitable for applications where a high stopping power is required (e.g. gamma ray detection). Single-crystal lead tungstate scintillators have been prepared for the Electromagnetic Calorimeter (ECAL) on the Compact Muon Solenoid, a large particle physics detector in Cessy, France.

LYSO (Lu_{1.8}Y_{0.2}SiO₅(Ce))—LYSO is comparable in density to BGO, but much faster and with much higher light output. LYSO is excellent for medical imaging applications.

Thallium-doped sodium iodide (NaI(Tl))—NaI(Tl) is by far the most widely used scintillator material. It is available in single-crystal form or a more rugged polycrystalline form, suitable for use in high vibration environments, such as wireline logging in the oil industry. Other applications include nuclear medicine, basic research, environmental monitoring, and aerial surveys.

Cerium-doped yttrium aluminum garnet (YAG(Ce))—YAG(Ce) has a wavelength of maximum emission of 550 nm, well-matched to red-resistive PMTs or photo-diodes. It is relatively fast (70 ns decay time) with a light output about ⅓ of that of NaI(Tl). YAG(Ce) exhibits properties that make it particularly attractive for electron microscopy applications, such as high electron conversion efficiency, good resolution, mechanical ruggedness, and long lifetime.

Silver-doped zinc sulfide (ZnS(Ag))—ZnS(Ag) is one of the oldest known inorganic scintillators; the first experiment making use of a scintillator by Sir William Crookes (1903) involved a ZnS screen. It is only available as a polycrystalline powder, however, making its use limited to thin screens primarily for particle radiation detection.

Calcium tungstate (CaWO₄), lutetium iodide (LuI₃), and zinc tungstate (ZnWO₄) are other common inorganic scintillators.

Gaseous Scintillators

Gaseous scintillators may include nitrogen and the noble gases helium, argon, krypton, and xenon, with helium and xenon receiving the most attention. The scintillation process is due to the de-excitation of single atoms excited by the passage of an incoming particle. This de-excitation is very rapid (about 1 ns), so the detector response is quite fast. In nuclear physics, gaseous detectors have been used to detect fission fragments or heavy charged particles.

Glasses

The most common glass scintillators are cerium-activated lithium or boron silicates. Since both lithium and boron have large neutron cross-sections, glass detectors are particularly well suited to the detection of thermal (slow) neutrons. Lithium is more widely used than boron since it has a greater energy release on capturing a neutron and therefore greater light output. Glass scintillators are, however, sensitive to electrons and gamma rays as well. Pulse height discrimination may be used for particle identification. Being very robust, they are also well-suited to harsh environmental conditions. Their response time is about 10 ns, but their light output is low, typically about 30% of that of anthracene.

A phosphor appliance for a smartphone may utilize any of the above scintillator materials depending on the desired detection. Further consideration of practicality warrants the specific examination and utilization of phosphor screens. Phosphors, such as coated inorganic phosphors gadolinum oxysulfide (GOS), coated on a substrate have been used in film imaging for decades. It is typically utilized as a radiology imaging screen, however, it may be utilized in a scintillator appliance for a portable electronic device, including a smartphone, as well. In this mode, rather than create an image, the scintillator creates light, which is detectable by the camera. GOS offers another advantage in that it does not contain any hazardous solvents, or Resource Conservation and Recovery Act (RCRA) hazardous chemicals, such as barium, permitting easier manufacturing, distribution, and legacy disposition.

In some embodiments, an appliance converts forms of ionizing radiation into visible light that is easily detectable by an electronic device. In some embodiments, the device is a smartphone with a digital camera. The appliance preferably includes an exterior housing with an attachment mechanism to couple the appliance to the electronic device. The housing may be made of any of a variety of synthetic or metal materials, including, but not limited to, aluminum or plastic. The housing is arranged in a manner to affix the appliance to the camera.

A number of different attachment mechanisms may be used within the spirit of the present invention, including, but not limited to, an elastic band such that the device may be worn as a bracelet, suction cups, a magnetic medium, a rotatable disk type device that accommodates different radiation screens and filters, a specialized adjustable clamp that accommodates a wide variety of cameras and aperture shapes, and an adhesive, including, but not limited to, a peel and stick adhesive.

The appliance also preferably includes a phosphor screen or other suitable fluor, including, but not limited to, a crystal or a phosphor, that emits light promptly after exposure, and an opacifer material that blocks ambient light from reaching the camera.

In some embodiments, a prompt phosphor is affixed in front of a smartphone camera aperture via an attachment mechanism. In some embodiments, the prompt phosphor is gadolinium oxysulfide (GOS). In some embodiments, a light membrane prevents ambient light from entering the aperture such that the only visible light going to the camera is that from the phosphor screen.

In some embodiments, the ionizing radiation, which may include, but is not limited to, gamma radiation, x-ray radiation, or high energy beta radiation, interacts with the phosphor, creating visible light that is easily detectable by the digital camera sensor. In some embodiments, app software monitors the amount of overall light being produced and correlates the intensity or light rate to a radiation intensity rate. In some embodiments, the radiation is reported in terms of milliroentgens per hour. In some embodiments, the amount of intensity is quantified over time and is extrapolated into an absorbed radiation. A visual interface on the display of the electronic device may demonstrate real time radiation rates and quantify dose.

Referring to FIG. 1, the x-ray/gamma radiation detector includes a scintillator appliance 10 and an electronic device 12. The scintillator appliance 10 includes a phosphor screen layer 14 and a backer layer 16 covering the phosphor screen layer 14. The phosphor screen layer 14 preferably includes a prompt phosphor. The backer layer 16 may be any material that permits gamma or x-ray radiation 18 to pass through but prohibits visible light 20 detectable by the digital camera sensor 26 from passing through. In some embodiments, the backer layer 16 is electrical tape. The phosphor screen layer 14 covers the camera aperture 22 of the electronic device 12. The gamma or x-ray radiation 18 passes through the backer layer 16. In some embodiments, the gamma or x-ray radiation 18 is light of any wavelength less than or equal to 1 nm. The radiation 18 interacts with the phosphor screen layer 14 and the electromagnetic radiation is converted to camera sensor-detectable light 21. The light 21 passes through the remainder of the phosphor screen layer 14, through the camera aperture 22, through the camera lens 24, and into the digital camera sensor 26, where it is detected. The light 21 may be of any wavelength easily detectable by the digital camera sensor 26. In some embodiments, the light 21 has a wavelength in the range of the visible light spectrum. In some embodiments, the light 21 has a wavelength in the range of 390 nm to 750 nm. The scintillator appliance 10 is mounted to the electronic device 12 such that no external visible light 20 reaches the digital camera sensor. An app or other program on the electronic device 12 calculates a radiation level based on the amount or rate of light 21 detection.

In some embodiments, a scintillator appliance includes an alpha-sensitive phosphor completely covered by a light-tight membrane. The alpha-sensitive phosphor interacts with alpha particles to produce camera sensor-detectable light. In some embodiments, the alpha-sensitive phosphor is gallium-doped zinc oxide (ZnO(Ga)). In some embodiments, the produced light is detected by the camera sensor to produce digital spatial tracks onto a CCD/CMOS digital image over time. In some embodiments, the data is correlated to calculate the amount of tracking on the digital image to a known exposure. In this way, the information may be read promptly without special laboratory equipment, processing chemicals, or a significant time delay.

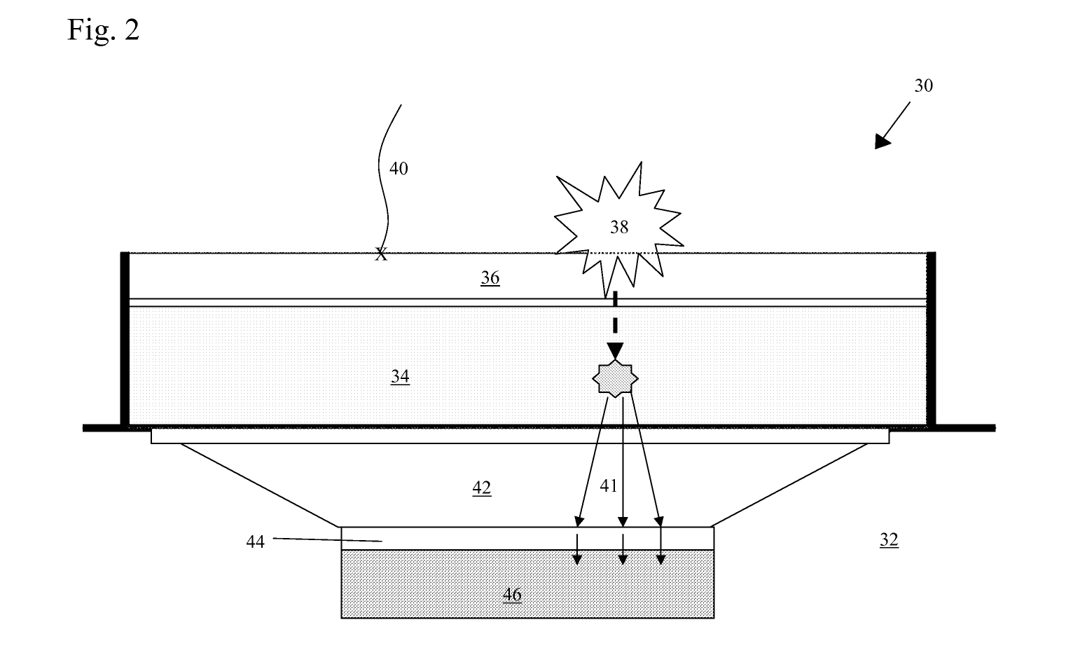

Referring to FIG. 2, the alpha particle/radon detector includes a scintillator appliance 30 and an electronic device 32. The scintillator appliance 30 includes a phosphor screen layer 34 and a backer layer 36 covering the phosphor screen layer 34. The phosphor screen layer 34 preferably includes a prompt phosphor. The backer layer 36 may be any material that permits alpha particles 38 to pass through but prohibits light 40 easily detectable by the digital camera sensor 46 from passing through. In some embodiments, the backer layer 36 is a layer of aluminized biaxially-oriented polyethylene terephthalate. In some embodiments, the backer layer 36 is about 5 micrometers thick. The phosphor screen layer 34 covers the camera aperture 42 of the electronic device 32. An alpha particle 38 passes through the backer layer 36. The alpha particle 38 interacts with the phosphor screen layer 34 and camera sensor-detectable light 41 is produced. The light 41 passes through the remainder of the phosphor screen layer 34, through the camera aperture 42, through the camera lens 44, and into the digital camera sensor 46, where it is detected. The light 41 may be of any wavelength easily detectable by the digital camera sensor 46. In some embodiments, the light 41 has a wavelength in the range of the visible light spectrum. In some embodiments, the light 41 has a wavelength in the range of 390 nm to 750 nm. The scintillator appliance 30 is mounted to the electronic device 32 such that no external visible light 40 reaches the digital camera sensor 46. An app or other program on the electronic device 32 calculates a radiation level based on the amount or rate of light 41 detection.

In some embodiments, the radiation detector includes filtration and may include any combination of enhanced high radiation detection, enhanced low energy detection, and multiple agent detection. The filters preferably include different materials or plastics of various densities. In some embodiments, a single screen contains a series of filters of different thicknesses or of different materials or the absence of filters in certain portions of the device. The precise choice may be determined by the environment to be monitored. The use of filters of several different thicknesses allows for an estimation of the energy/wavelength of the incident radiation.

In some embodiments, gamma radiation, x-ray radiation, and high-energy beta radiation pass through the backing layer and interact with or are filtered by various filters. Filter materials may include, but are not limited to, copper, cadmium, aluminum, lead, and plastic. In some embodiments, the density pattern of filters is in the form of a digital image that is quantifiable and comparable to a reference pattern, thereby indicating the dose and penetrating power (i.e., energy) of the incoming radiation, similar to a film badge application and density pattern referencing. In some embodiments, only a digital signal is used for radon. In some embodiments, the signal is digitally counted, rather than a film being processed.

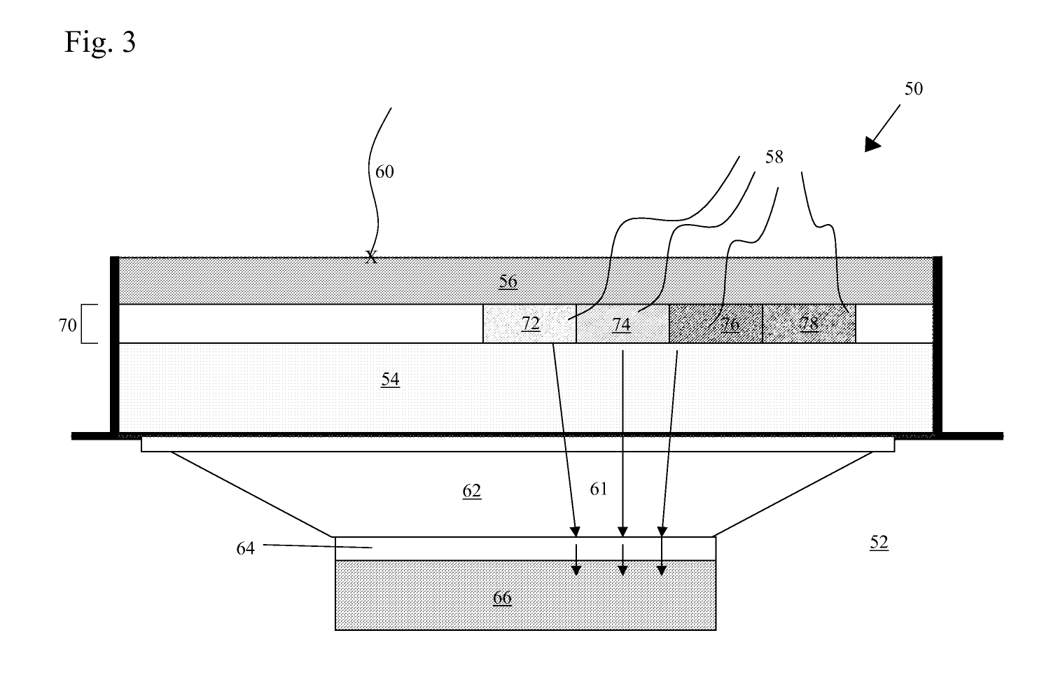

Referring to FIG. 3, the enhanced x-ray radiation, gamma radiation, high energy beta radiation detector includes a scintillator appliance 50 and an electronic device 52. The scintillator appliance 50 includes a phosphor screen layer 54, a backer layer 56, and a filter layer 70 between the phosphor screen layer 54 and the backer layer 56. The phosphor screen layer 54 preferably includes a prompt phosphor. The backer layer 56 may be any material that permits x-ray radiation, gamma radiation, or high energy beta radiation 58 to pass through but prohibits light 60 easily detectable by the digital camera sensor 66 from passing through. In some embodiments, the backer layer 56 is electrical tape. In the embodiment shown in FIG. 3, the filter layer 70 includes multiple filter materials 72, 74, 76, 78 arranged in the filter layer 70. In some embodiments, the filter materials 72, 74, 76, 78 are arranged side-by-side in a predetermined arrangement. In other embodiments, two or more different filter materials may be stacked in the filter layer to provide one or more combination filter areas with desired filtering properties. In some embodiments, the filter materials are aluminum 72, copper 74, cadmium 76, and lead 78. The phosphor screen layer 54 covers the camera aperture 62 of the electronic device 52. Radiation 58 passes through the opaque backer 56. The radiation 58 passes through the filter materials 72, 74, 76, 78 to different degrees depending on the energy of the radiation 58.

The filter materials 72, 74, 76, 78 cover only a portion of the phosphor screen layer 54 such that some radiation 58 passes to the phosphor screen layer 54 without filtration by the filter layer 70. Radiation 58 passing into the phosphor screen layer 54 interacts with the phosphor screen layer 54 and camera sensor-detectable light 61 is produced. The light 61 passes through the remainder of the phosphor screen layer 54, through the camera aperture 62, through the camera lens 64, and into the digital camera sensor 66, where it is detected. The light 61 may be of any wavelength easily detectable by the digital camera sensor 66. In some embodiments, the light 61 has a wavelength in the range of the visible light spectrum. In some embodiments, the light 61 has a wavelength in the range of 390 nm to 750 nm. The scintillator appliance 50 is mounted to the electronic device 52 such that no external visible light 60 reaches the digital camera sensor 66. An app or other program on the electronic device 52 calculates a radiation level based on the amount or rate of light 61 detection. In some embodiments, since differing levels of radiation are detected by the digital camera sensor 66 spatially behind the different filter materials 72, 74, 76, 78, the spatial detection level differences are used to determine an energy distribution of the detected radiation.

The scintillation appliance may take on forms other than that shown specifically in FIG. 3. Filter materials, phosphors and any combinations thereof may be utilized to create different responses and photon outputs to the digital camera sensors. In some embodiments, a filter and phosphor array is assembled so that a high-energy filter is coupled to a phosphor that emits blue light, and a low-energy filter is coupled to a phosphor that creates green light. In some embodiments, high-energy gamma radiation, high-energy x-ray radiation, or high energy beta radiation passes through a lead layer and creates blue light. Lower energy x-rays pass through without filtration and create green light detected by the digital camera sensor in the electronic device. Any combination of phosphors and filters may be arranged in front of the aperture. Since a digital camera is capable of discerning the differences in color output, the mentioned arrangement may be used to discern the amount and presence of high energy versus low energy radiation, which is often valuable for quantifying dose equivalency in human tissue and for determining type of radiation, including identifying the type and source of radiation, allowing the reader to make an informed decision about personal protection.

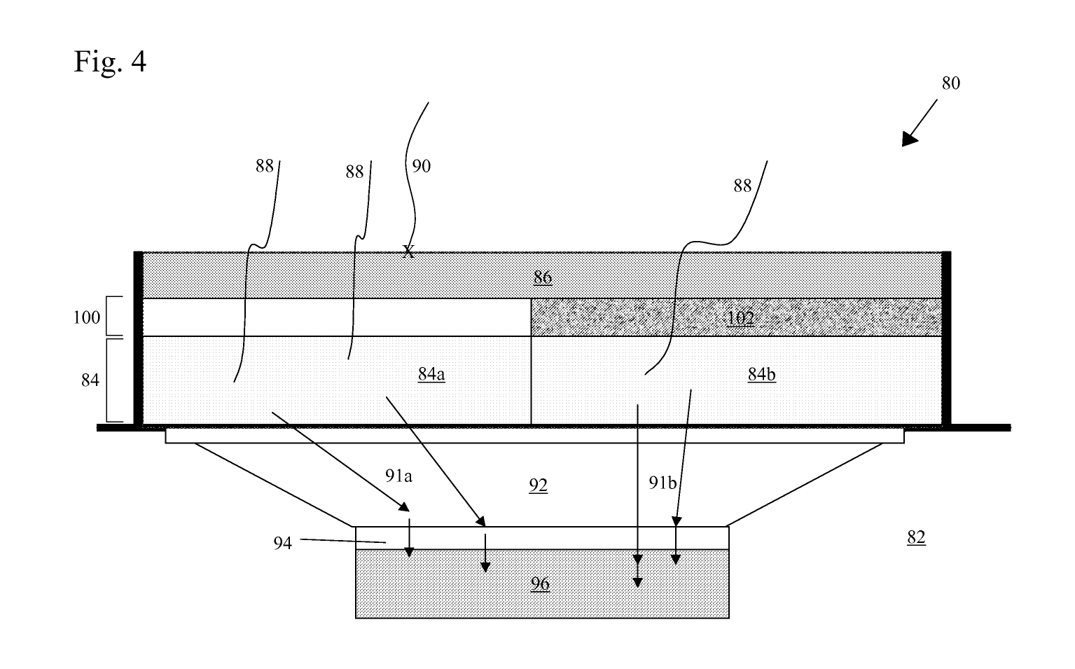

Referring to FIG. 4, the enhanced x-ray radiation, gamma radiation, high energy beta radiation detector includes a scintillator appliance 80 and an electronic device 82. The scintillator appliance 80 includes a phosphor screen layer 84, a backer layer 86, and a filter layer 100 between the phosphor screen layer 84 and the backer layer 86. The filter layer 100 includes a filter material 102 that only fills a portion of the filter layer 100. The phosphor screen layer 84 includes a first portion 84a below a non-filtering portion of the filter layer 100 and a second portion 84b below the filter material 102 of the filter layer 100. In some embodiments, the first screen layer portion 84a includes the phosphor terbium-doped gadolinium oxysulfie (Gd₂O₂S(Tb)), and the second screen layer portion 84b includes the phosphor cadmium tungstenate (CaWO₄). The backer layer 86 may be any material that permits x-ray radiation, gamma radiation, or high energy beta radiation 88 to pass through but prohibits light 90 easily detectable by the digital camera sensor 96 from passing through. In some embodiments, the backer layer 86 is electrical tape. In some embodiments, the filter material 102 is lead. The phosphor screen layer 84 covers the camera aperture 92 of the electronic device 82. Radiation 88 to be detected passes through the backer layer 86. The radiation 88 may or may not pass through the filter material 102 depending on the energy of the radiation 88. The filter material 102 cover only a portion 84b of the phosphor screen layer 84 such that some radiation 88 passes to the phosphor screen layer 84 without filtration by the filter layer 100.

Radiation 88 passing into the first portion 84a of the phosphor screen layer 84 interacts with the phosphor and camera sensor-detectable light of a first color 91a is produced. The light 91a passes through the remainder of the phosphor screen layer 84, through the camera aperture 92, through the camera lens 94, and into the digital camera sensor 96, where it is detected. Radiation 88 passing into the second portion 84b of the phosphor screen layer 84 interacts with the phosphor and camera sensor-detectable light of a second color 91b is produced. In some embodiments, only high energy x-rays pass through the filter material 102. The light 91b passes through the remainder of the phosphor screen layer 84, through the camera aperture 92, through the camera lens 94, and into the digital camera sensor 96, where it is detected. The light 91a, 91b may be of any wavelengths easily detectable by the digital camera sensor 96. In some embodiments, the first light 91a has a wavelength in the range of green visible light. In some embodiments, the first light 91a has a wavelength in the range of 490 nm to 560 nm. In some embodiments, the second light 91b has a wavelength in the range of blue visible light. In some embodiments, the second light 91b has a wavelength in the range of 450 nm to 490 nm. The scintillator appliance 80 is mounted to the electronic device 82 such that no external visible light 90 reaches the digital camera sensor 96. An app or other program on the electronic device 82 calculates a radiation level based on the amount or rate of light 91a, 91b detection. In some embodiments, since differing wavelengths of light are detected by the digital camera sensor 96 behind the different phosphor screens 84a, 84b, the quantities of first light 91a and second light 91b are used to determine an energy distribution of the detected radiation.

In some embodiments, neutrons thermalize and slow while passing through a layer of a hydrogenous medium. The slowed neutrons then pass through a backer layer and into a phosphor screen layer. The neutrons interact with the neutron-sensitive phosphor in the phosphor screen layer to produce camera sensor-detectable light. The produced light is then detected by the digital camera sensor of the electronic device. An app or other program on the electronic device preferably calculates a radiation level based on the amount or rate of light detection.

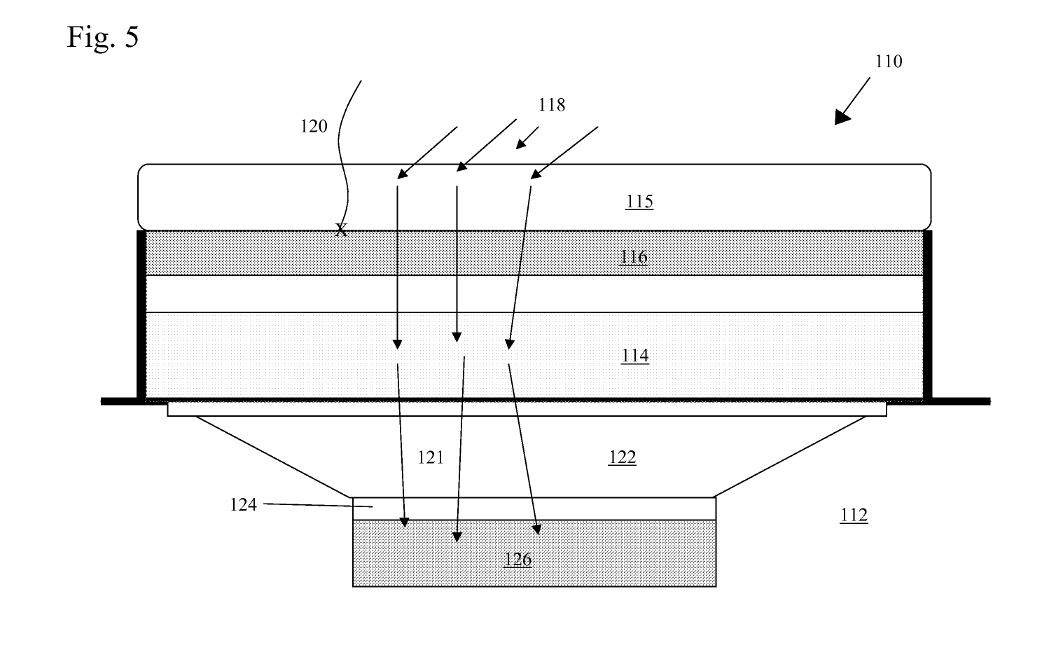

Referring to FIG. 5, the enhanced neutron-sensitive detector includes a scintillator appliance 110 and an electronic device 112. The scintillator appliance 110 includes a phosphor screen layer 114 and a backer layer 116 covering the phosphor screen layer 114. The phosphor screen layer 114 preferably includes a neutron-sensitive phosphor. In some embodiments, the neutron-sensitive phosphor is zinc sulfide (ZnS). The backer layer 116 may be any material that permits alpha particles 118 to pass through but prohibits light 120 easily detectable by the digital camera sensor 126 from passing through. In some embodiments, the backer layer 116 is electrical tape. The phosphor screen layer 114 covers the camera aperture 122 of the electronic device 112. A hydrogenous layer 115 covers the backer layer 116. In some embodiments, the hydrogenous layer 116 includes water-extended polyethylene (WEP). A neutron 118 slows as it passes through the hydrogenous layer 115. The neutron 118 then passes through the backer layer 116 and into the phosphor screen layer 114, where it interacts with the phosphor to produce camera sensor-detectable light 121. The light 121 passes through the remainder of the phosphor screen layer 114, through the camera aperture 122, through the camera lens 124, and into the digital camera sensor 126, where it is detected. The light 121 may be of any wavelength easily detectable by the digital camera sensor 126. In some embodiments, the light 121 has a wavelength in the range of the visible light spectrum. In some embodiments, the light 121 has a wavelength in the range of 390 nm to 750 nm. The scintillator appliance 110 is mounted to the electronic device 112 such that no external visible light 120 reaches the digital camera sensor 126. An app or other program on the electronic device 112 calculates a radiation level based on the amount or rate of light 121 detection.

In some embodiments, the scintillator probe is coupled to one end of an optical fiber and the other end of the optical fiber is attached to a camera aperture cover. Ionizing radiation interacts with the phosphor in the scintillator appliance, creating visible light that is easily detectable by the digital camera sensor. The optical fiber receives the generated camera sensor-detectable light at its first end and transmits the light to its second end, thereby permitting remote detection of radiation by the digital camera sensor. The scintillator probe only allows visible light generated by the radiation interaction with the phosphor to reach the first end of the optical fiber. The camera aperture cover only permits visible light transported by the optical fiber to reach the camera aperture.

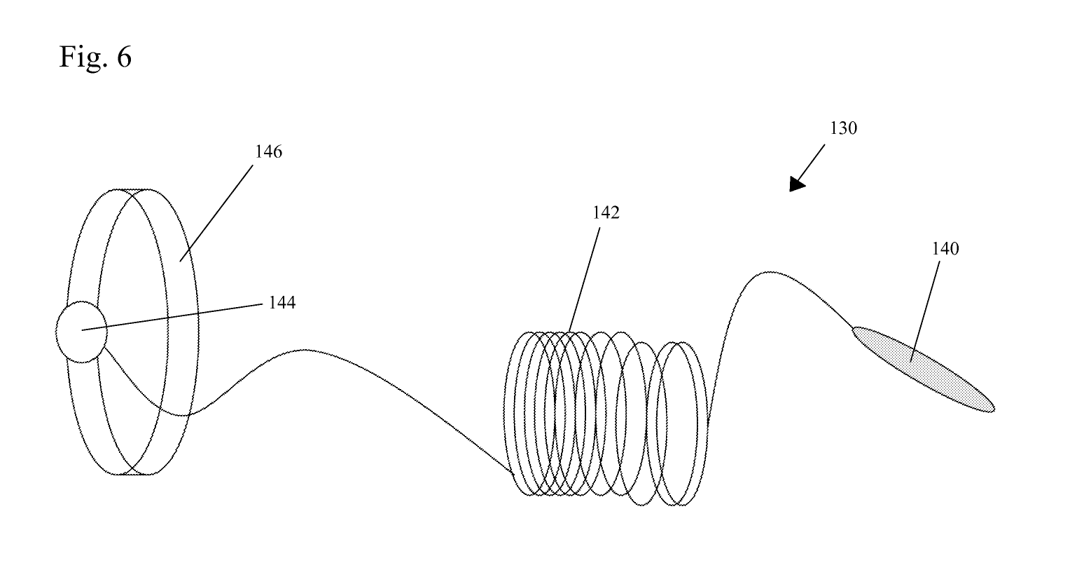

Referring to FIG. 6, the remote scintillator appliance 130 includes a scintillator probe 140, an optical fiber 142, a camera aperture cover 144, and an attachment mechanism 146. The scintillator probe 140 may have any of the previously-described scintillator appliance structures. In some embodiments, the scintillator probe includes a phosphor screen layer and a backer layer covering the phosphor screen layer. The backer layer may be any material that permits radiation of the type to be detected to pass through but prohibits external visible light detectable by the digital camera sensor from passing through. The phosphor screen layer covers the first end of the optical fiber 142. The radiation interacts with the phosphor screen layer and the electromagnetic radiation is converted to camera sensor-detectable light. The light passes through the remainder of the phosphor screen layer, through the length of the optical fiber 142, through the camera aperture, through the camera lens, and into the digital camera sensor, where it is detected. The light may be of any wavelength easily detectable by the digital camera sensor. The camera aperture cover 144 is mounted to the electronic device such that no external visible light reaches the digital camera sensor. The attachment mechanism 146 couples the camera aperture cover 144 to the camera aperture. An app or other program on the electronic device calculates a radiation level based on the amount or rate of light detection.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A method of measuring radiation comprising the steps of:
a) reversibly coupling a scintillator appliance to a camera aperture of a hand-held electronic device such that the scintillator appliance prohibits all ambient visible light detectable by a digital camera sensor of the electronic device from reaching the digital camera sensor and such that the scintillator appliance produces visible light detectable by the digital camera sensor upon interaction with at least one form of radiation; and
b) activating the hand-held electronic device to detect the visible light produced by the scintillator appliance.

2. The method of claim 1 further comprising the step of running a software application on the hand-held electronic device to convert an amount of the visible light produced by the scintillator appliance and detected by the digital camera sensor into a radiation level.

3. The method of claim 1 further comprising the step of removing the scintillator appliance from the camera aperture.

4. The method of claim 3 further comprising the step of activating the hand-held electronic device to acquire a digital image using the digital camera sensor with the scintillator appliance removed from the camera aperture.

5. A radiation detector comprising:
a hand-held electronic device comprising a digital camera sensor sensing detectable visible light through a camera aperture in the electronic device; and
a scintillator appliance reversibly coupleable to the camera aperture of the electronic device, the scintillator appliance comprising:
a phosphor screen layer comprising at least one phosphor capable of producing visible light detectable by a digital camera sensor of an electronic device upon exposure to at least one type of radiation; and
a backer layer permitting passage of the radiation to the phosphor screen layer and prohibiting passage of visible light detectable by the digital camera sensor.

6. The radiation detector of claim 5, wherein the hand-held electronic device is selected from the group consisting of a cellular telephone, a smartphone, a laptop computer, and a tablet computer.

7. The radiation detector of claim 5, wherein the phosphor screen layer comprises at least one compound selected from the group consisting of gallium-doped zinc oxide, terbium-doped gadolinium oxysulfide, cadmium tungstate, and gadolinium oxysulfide.

8. The radiation detector of claim 5, wherein the scintillator appliance further comprises at least one filter layer located between the phosphor screen layer and the backer layer, the filter layer comprising at least one filter material capable of selectively filtering radiation based on at least one radiation criterion.

9. The radiation detector of claim 8, wherein the at least one filter material is selected from the group consisting of copper, cadmium, aluminum, lead, and plastic.

10. The radiation detector of claim 8, wherein the at least one filter material comprises at least two filter materials.

11. The radiation detector of claim 5, wherein the at least one phosphor comprises a first phosphor generating visible light at a first wavelength and a second phosphor generating visible light at a second wavelength.

12. The radiation detector of claim 5, wherein the scintillator appliance further comprises a hydrogenous layer covering the backer layer.

13. A scintillator appliance comprising:
a phosphor screen layer comprising at least one phosphor capable of producing visible light detectable by a digital camera sensor of a hand-held electronic device upon exposure to at least one type of radiation;
a backer layer permitting passage of the radiation to the phosphor screen layer and prohibiting passage of visible light detectable by the digital camera sensor; and
an attachment mechanism reversibly attaching the scintillator appliance to a camera aperture of the electronic device.

14. The scintillator appliance of claim 13, wherein the phosphor screen layer comprises at least one compound selected from the group consisting of gallium-doped zinc oxide, terbium-doped gadolinium oxysulfide, cadmium tungstate, and gadolinium oxysulfide.

15. The scintillator appliance of claim 13 further comprising at least one filter layer located between the phosphor screen layer and the backer layer, the filter layer comprising at least one filter material capable of selectively filtering radiation based on at least one radiation criterion.

16. The scintillator appliance of claim 15, wherein the at least one filter material is selected from the group consisting of copper, cadmium, aluminum, lead, and plastic.

17. The scintillator appliance of claim 15, wherein the at least one filter material comprises at least two filter materials.

18. The scintillator appliance of claim 13, wherein the at least one phosphor comprises a first phosphor generating visible light at a first wavelength and a second phosphor generating visible light at a second wavelength.

19. The scintillator appliance of claim 13 further comprising a hydrogenous layer covering the backer layer.

20. The scintillator appliance of claim 13 further comprising:
a camera aperture cover; and
an optical fiber having a first end receiving visible light produced by the at least one phosphor in the phosphor screen layer and a second end coupled to the camera aperture cover, the optical fiber transmitting the visible light to the camera aperture by way of the second end. {00347105.DOC 6}
